(19) United States
(12) Patent Application Publication
(10) Pub. No.: US 2024/0132076 A1
(43) Pub. Date: Apr. 25, 2024

(54) ROAD SOUND DETECTION

(71) Applicant: Toyota Motor Engineering & Manufacturing North America, Inc., Plano, TX (US)

(72) Inventors: Emrah Akin Sisbot, Mountain View, CA (US); Seyhan Ucar, Mountain View, CA (US); Takamasa Higuchi, Mountain View, CA (US); Yongkang Liu, Mountain View, CA (US); Kentaro Oguchi, Mountain View, CA (US)

(73) Assignees: Toyota Motor Engineering & Manufacturing North America, Inc., Plano, TX (US); Toyota Jidosha Kabushiki Kaisha, Aichi-ken (JP)

(21) Appl. No.: 18/048,281

(22) Filed: Oct. 19, 2022

(51) Int. Cl. B60W 40/06; B60W 40/105

(52) U.S. Cl. CPC B60W 40/06; B60W 40/105; B60W 2420/54; B60W 2552/35; B60W 2554/4046; B60W 2556/65

(57) ABSTRACT

A vehicle system of a vehicle may include a controller programmed to receive sensor data from one or more vehicle sensors as the vehicle drives along a road, determine whether the vehicle is approaching a road anomaly based on the sensor data, and upon determination that the vehicle is approaching the road anomaly, begin recording audio and continue recording audio until after the vehicle interacts with the road anomaly.

### TECHNICAL FIELD

The present specification relates to road sound detection when a vehicle interacts with an anomaly.

### BACKGROUND

As a vehicle is driven along a road, if the vehicle hits an anomaly (e.g., a speed bump or a pot hole), the vehicle may be damaged by the interaction with the anomaly. The damage caused to the vehicle may require the vehicle to be serviced by a vehicle technician to repair the damage. However, diagnosing the damage to the vehicle may be difficult, which may increase the time and/or cost of repairing the vehicle. As such, more efficient ways of diagnosing vehicle damage may be desirable.

One way to diagnose damage to a vehicle caused by interaction with an anomaly is to listen to a sound that occurs when the vehicle interacts with the anomaly and shortly thereafter. In particular, a vehicle technician may be able to identify the damage that occurred to the vehicle based on the sound caused by the vehicle interacting with the anomaly. However, this is typically not possible because the sound that occurs when a vehicle hits an anomaly cannot typically be reproduced later for a vehicle technician to listen to. Accordingly, an improved method of road sound detection may be desirable.

### SUMMARY

In an embodiment, a vehicle system of a vehicle may include a controller. The controller may be programmed to receive sensor data from one or more vehicle sensors as the vehicle drives along a road, and determine whether the vehicle is approaching a road anomaly based on the sensor data. Upon determination that the vehicle is approaching the road anomaly, the controller may begin recording audio and continue recording audio until after the vehicle interacts with the road anomaly.

In another embodiment, a vehicle system may include a controller. The controller may be programmed to continually record audio, store a predetermined amount of the most recently recorded audio in a buffer, receive sensor data from one or more vehicle sensors, and determine whether the vehicle has interacted with an anomaly based on the sensor data. Upon determination that the vehicle has interacted with an anomaly, the controller may extract a portion of the audio from the buffer.

In another embodiment, a method may include receiving sensor data from one or more vehicle sensors of a vehicle as the vehicle drives along a road, and determining whether the vehicle is approaching a road anomaly based on the sensor data. Upon determination that the vehicle is approaching the road anomaly, the method may include beginning to record audio and continuing to record audio until after the vehicle interacts with the road anomaly.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 depicts an example environment to perform road sound detection according to one or more embodiments shown and described herein;

FIG. 2 depicts a schematic diagram of a vehicle system, according to one or more embodiments shown and described herein;

FIG. 3 depicts the memory modules of the vehicle system of FIG. 2, according to one or more embodiments shown and described herein;

FIG. 4 depicts a flowchart of an example method of operating the vehicle system of FIG. 2 to perform road sound detection, according to one or more embodiments shown and described herein; and

FIG. 5 depicts a flowchart of another example method of operating the vehicle system of FIG. 2 to perform road sound detection, according to one or more embodiments shown and described herein.

### DETAILED DESCRIPTION

The embodiments disclosed herein include a method and system for road sound detection. As a vehicle drives along a road, a vehicle system may detect when the vehicle is approaching a road anomaly. When the vehicle system detects that the vehicle is about to interact with a road anomaly, the vehicle may begin recording audio so as to record audio of the vehicle interacting with the anomaly. The recorded audio may be stored by the vehicle system. If the interaction with the anomaly causes any damage to the vehicle, the recorded audio of the interaction between the vehicle and the anomaly can later be played back for a vehicle technician in order to assist the technician in diagnosing the damage caused to the vehicle.

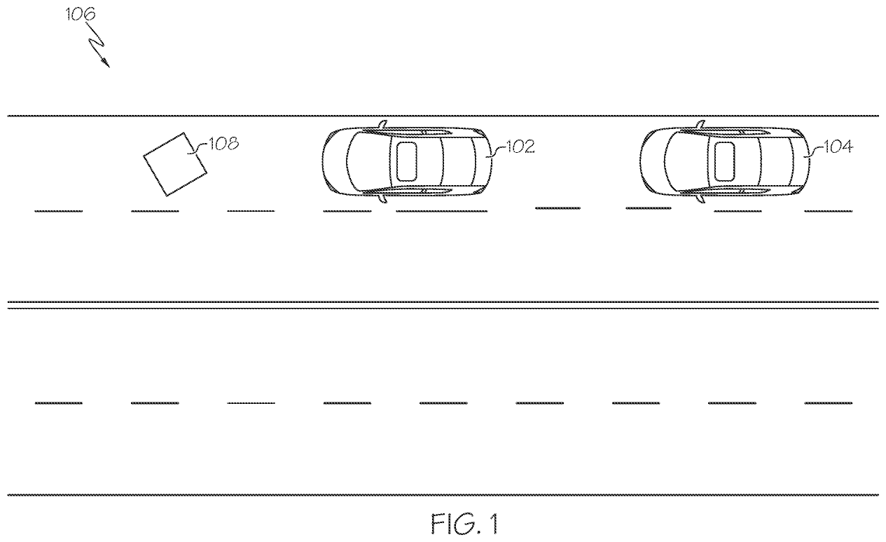

Turning now to the figures, FIG. 1 schematically depicts a scenario in which road sound detection may be implemented. In the example of FIG. 1, vehicles 102 and 104 drive along a road 106. The vehicle 102 is approaching a road anomaly 108. As disclosed herein, a road anomaly may be any object on a road, or feature of a road, that may interact with a vehicle so as to cause damage to the vehicle. As disclosed herein, a road anomaly may include, but is not limited to, a pot hole, a speed bump, an object or obstruction on the road, and the like. As the vehicle 102 approaches the anomaly 108, the vehicle 102 may begin recording audio so as to record audio when the vehicle 102 interacts with the anomaly 108, as disclosed herein. The vehicle 102 may be an automobile or any other passenger or non-passenger vehicle such as, for example, a terrestrial, aquatic, and/or airborne vehicle. The vehicle 102 may be an autonomous vehicle that navigates its environment with limited human input or without human input.

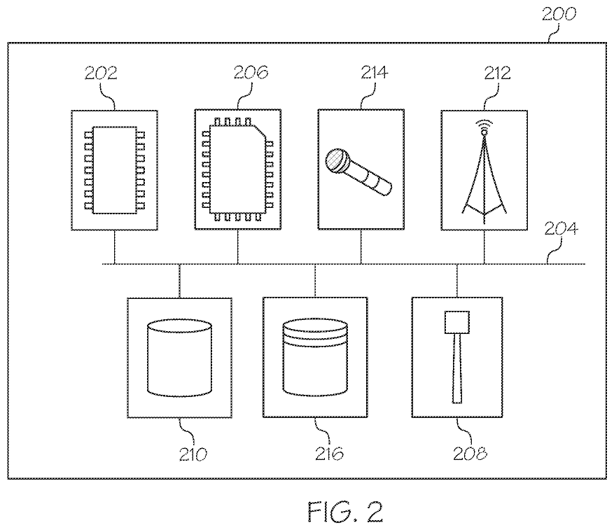

FIG. 2 depicts a vehicle system 200 that may be included in the vehicle 102 and/or the vehicle 104 of FIG. 1. In the example of FIG. 2, the vehicle system 200 includes one or more processors 202, a communication path 204, one or more memory modules 206, a satellite antenna 208, one or more vehicle sensors 210, a network interface hardware 212, a microphone 214, and a data storage component 216, the details of which will be set forth in the following paragraphs.

Each of the one or more processors 202 may be any device capable of executing machine readable and executable instructions. Accordingly, each of the one or more processors 202 may be a controller, an integrated circuit, a microchip, a computer, or any other computing device. The one or more processors 202 are coupled to a communication path 204 that provides signal interconnectivity between various modules of the vehicle system 200. Accordingly, the communication path 204 may communicatively couple any number of processors 202 with one another, and allow the modules coupled to the communication path 204 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 204 may be formed from any medium that is capable of transmitting a signal such as, for example, conductive wires, conductive traces, optical waveguides, or the like. In some embodiments, the communication path 204 may facilitate the transmission of wireless signals, such as Wi-Fi, Bluetooth®, Near Field Communication (NFC) and the like. Moreover, the communication path 204 may be formed from a combination of mediums capable of transmitting signals. In one embodiment, the communication path 204 comprises a combination of conductive traces, conductive wires, connectors, and buses that cooperate to permit the transmission of electrical data signals to components such as processors, memories, sensors, input devices, output devices, and communication devices. Accordingly, the communication path 204 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The vehicle system 200 includes one or more memory modules 206 coupled to the communication path 204. The one or more memory modules 206 may comprise RAM, ROM, flash memories, hard drives, or any device capable of storing machine readable and executable instructions such that the machine readable and executable instructions can be accessed by the one or more processors 202. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 206. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components.

Referring still to FIG. 2, the vehicle system 200 comprises a satellite antenna 208 coupled to the communication path 204 such that the communication path 204 communicatively couples the satellite antenna 208 to other modules of the vehicle system 200. The satellite antenna 208 is configured to receive signals from global positioning system satellites. Specifically, in one embodiment, the satellite antenna 208 includes one or more conductive elements that interact with electromagnetic signals transmitted by global positioning system satellites. The received signal is transformed into a data signal indicative of the location (e.g., latitude and longitude) of the satellite antenna 208, and consequently, the vehicle containing the vehicle system 200.

The vehicle system 200 comprises one or more vehicle sensors 210. Each of the one or more vehicle sensors 210 is coupled to the communication path 204 and communicatively coupled to the one or more processors 202. The one or more vehicle sensors 210 may include, but are not limited to, LiDAR sensors, RADAR sensors, optical sensors (e.g., cameras, laser sensors), proximity sensors, location sensors (e.g., GPS modules), and the like. In embodiments, the vehicle sensors 210 may monitor the surroundings of the vehicle and may detect road anomalies, as disclosed herein. In some examples, the vehicle sensors 210 may also monitor the behavior of other vehicles, as disclosed herein.

Still referring to FIG. 2, the vehicle system 200 comprises network interface hardware 212 for communicatively coupling the vehicle system to one or more external devices, such as a remote computing device (e.g., a cloud server or edge server) or other vehicles (e.g., the vehicle 104 of FIG. 1). The network interface hardware 212 can be communicatively coupled to the communication path 204 and can be any device capable of transmitting and/or receiving data via a network. Accordingly, the network interface hardware 212 can include a communication transceiver for sending and/or receiving any wired or wireless communication. For example, the network interface hardware 212 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, the network interface hardware 212 includes hardware configured to operate in accordance with the Bluetooth® wireless communication protocol. In embodiments, the network interface hardware 212 of the vehicle system 200 may transmit data about anomalies detected by the vehicle system 200, as disclosed in further detail below.

Still referring to FIG. 2, the vehicle system 200 comprises a microphone 214. The microphone 214 may record audio when the vehicle 102 interacts with an anomaly (e.g., when the vehicle 102 hits a speed bump or a pot hole), as disclosed herein. In some examples, the microphone 214 may be positioned outside of the vehicle 102, and in other examples, the microphone 214 may be positioned inside the vehicle 102. In some examples, the vehicle system 200 may include multiple microphones 214 placed in different locations in the vehicle 102. In these examples, certain microphones may better record audio of the vehicle 102 interacting with an anomaly than other microphones.

Still referring to FIG. 2, the vehicle system 200 comprises a data storage component 216. The data storage component 216 may store data used by various components of the vehicle system 200. For example, the data storage component 216 may store sensor data collected by the vehicle sensors 210 and/or audio recorded by the microphone 214.

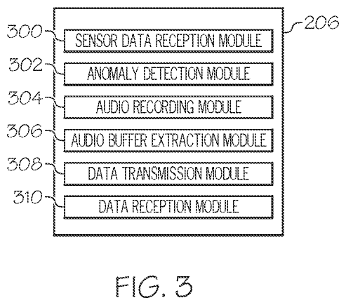

Now referring to FIG. 3, the one or more memory modules 206 of the vehicle system 200 include a sensor data reception module 300, an anomaly detection module 302, an audio recording module 304, an audio buffer extraction module 306, a data transmission module 308, and a data reception module 310. Each of the sensor data reception module 300, the anomaly detection module 302, the audio recording module 304, the audio buffer extraction module 306, the data transmission module 308, and the data reception module 310 may be a program module in the form of operating systems, application program modules, and other program modules stored in the one or more memory modules 206. In some examples, the program module may be stored in a remote storage device that may communicate with the vehicle system 200. Such a program module may include, but is not limited to, routines, subroutines, programs, objects, components, data structures and the like for performing specific tasks or executing specific data types as will be described below.

The sensor data reception module 300 may receive sensor data from the one or more vehicle sensors 210. In particular, the sensor data reception module 300 may receive sensor data that may indicate that the vehicle 102 is approaching an anomaly. In one example, the sensor data reception module 300 may receive image data captured by a forward-facing camera. However, in other examples, the sensor data reception module 300 may receive other sensor data.

The anomaly detection module 302 may analyze the sensor data received by the sensor data reception module 300 to determine whether the vehicle 102 is approaching an anomaly. In one example, the anomaly detection module 302 may perform image analysis on one or more images captured by front-facing cameras. That is, the anomaly detection module 302 may perform image analysis of a portion of the road being approached by the vehicle 102 to determine if an anomaly is present. In some examples, a machine learning algorithm may be used to identify road anomalies based on image data (e.g., the “You Only Look Once” algorithm). The anomaly detection module 302 may be an image segmentation model, an object detection model, an object classification model, or any other model for recognizing an anomaly. The anomaly detection module 302 may include a machine learning model including, but not limited to, supervised learning models such as neural networks, decision trees, linear regression, and support vector machines, unsupervised learning models such as Hidden Markov models, k-means, hierarchical clustering, and Gaussian mixture models, and reinforcement learning models such as temporal difference, deep adversarial networks, and Q-learning. In other examples, other types of image processing techniques may be performed to identify road anomalies. In some examples, the anomaly detection module 302 may analyze data from other types of sensors (e.g., LiDAR, proximity sensors, and the like) to determine if the vehicle 102 is approaching an anomaly.

In another example, the anomaly detection module 302 may analyze the sensor data received by the sensor data reception module 300 to identify unusual behavior of other vehicles, which may indicate the presence of a road anomaly. For instance, in the example of FIG. 1, the vehicle 104 may receive sensor data (e.g., images or video), indicative of the behavior of the vehicle 102. If the vehicle 102 suddenly brakes or changes trajectory, this may indicate that the vehicle 102 was about to hit an anomaly. As such, the vehicle 104 may determine that the vehicle 102 likely encountered an anomaly, and that the vehicle 104 will likely encounter the same anomaly as they approach the location where the unusual behavior of vehicle 102 was detected.

If an anomaly is detected, the anomaly detection module 302 may determine a location of the anomaly (e.g., a distance between the vehicle 102 and the detected anomaly) based on the received sensor data. In some examples, the anomaly detection module 302 may determine an estimated time when the vehicle 102 will reach a detected anomaly based on the distance between the vehicle 102 and the detected anomaly and a speed of the vehicle 102.

The audio recording module 304 may cause the microphone 214 to begin recording audio. In particular, the audio recording module 304 may cause the microphone 214 to record audio when the vehicle 102 interacts with the anomaly, as disclosed herein.

In one example, the audio recording module 304 may cause the microphone 214 to begin recording audio when the anomaly detection module 302 determines that a distance between the vehicle 102 and a detected anomaly is less than a predetermined threshold distance (e.g., less than 20 feet). In another example, the audio recording module 304 may cause the microphone 214 to begin recording audio when the anomaly detection module 302 determines that a time when the vehicle 102 is expected to reach the anomaly is less than a predetermined threshold time in the future (e.g., less than 5 seconds).

In some examples, the audio recording module 304 may begin recording audio upon being triggered by an occupant of the vehicle 102. For example, the interior of the vehicle 102 may have a button that can be pressed to begin recording audio (e.g., on the vehicle dashboard). As such, if an occupant of the vehicle 102 notices that the vehicle 102 is approaching an anomaly, the occupant may press the button, which may trigger the audio recording module 304 to cause the microphone 214 to begin recording audio.

In some examples, the audio recording module 304 may cause the microphone 214 to begin recording audio after receiving a notification indicating that the vehicle 102 is approaching an anomaly. For example, the vehicle 102 may receive map data from an edge server indicating that a particular location is known to contain a road anomaly. As such, the audio recording module 304 may cause the microphone 214 to begin recording audio when the vehicle 102 approaches the location of the known anomaly. In other examples, the audio recording module 304 may cause the microphone 214 to begin recording audio when the vehicle 102 or the vehicle 104 receives an indication from another vehicle that an anomaly has been detected at a particular location. For instance, in the example of FIG. 1, the vehicle 102 may detect the anomaly 108 and may send a notification to the vehicle 104 (e.g., using vehicle-to-vehicle communication) indicating the location of the anomaly 108. As such, the audio recording module 304 of the vehicle 104 may cause the microphone 214 of the vehicle 104 to begin recording audio as the vehicle 104 approaches the location indicated by the vehicle 102 as containing the anomaly 108.

Once the audio recording module 304 causes the microphone 214 to begin recording audio, the microphone 214 may continue recording audio until after the vehicle 102 passes the detected anomaly, such that the microphone 214 records the entire interaction between the vehicle 102 and the anomaly. In some examples, the microphone 214 may continue recording audio for a time period after the vehicle 102 passes the anomaly. This may allow a technician to not only hear the sound when the vehicle 102 hit the anomaly, but also to hear the sound of the vehicle shortly after the anomaly was hit, which may give a stronger indication as to the nature of the damage to the vehicle.

In one example, once the microphone 214 starts recording audio, the microphone 214 may continue recording audio for a predetermined time period (e.g., 20 seconds). In another example, once the microphone 214 starts recording audio, the microphone 214 may continue recording audio until the vehicle 102 travels a predetermined distance (e.g., 40 feet). In another example, once the microphone 214 starts recording audio, the microphone 214 may continue recording audio until the vehicle 102 has traveled a certain distance past the anomaly (e.g., 20 feet). In another example, once the microphone 214 starts recording audio, the microphone 214 may continue recording audio until the vehicle 102 has traveled past the anomaly for a certain period of time (e.g., 5 seconds). In embodiments, once the audio recording module 304 causes the microphone 214 to start recording audio, the audio recording module 304 may cause the microphone 214 to stop recording audio once the appropriate time has passed, or the vehicle has traveled the appropriate distance, as discussed above.

Referring still to FIG. 3, the audio buffer extraction module 306 may extract audio from of a buffer of recorded audio, as disclosed herein. In some instances, an anomaly may not be detected until the vehicle 102 reaches the anomaly. For example, the sensor data may fail to identify that the vehicle 102 is approaching an anomaly. In these instances, the anomaly detection module 302 may detect that the vehicle 102 has hit an anomaly by analyzing data associated with the motion of the vehicle 102 (e.g., speed, trajectory, acceleration). For example, the anomaly detection module 302 may determine that the vehicle 102 has hit an anomaly if the vehicle 102 has a sudden change in speed or acceleration, or a sudden change in trajectory or angle of the wheels of the vehicle. However, once the anomaly detection module 302 detects that the vehicle 102 has hit an anomaly, it may be too late to record audio of the interaction between the vehicle 102 and the anomaly, since most of the interaction has already occurred. As such, in some examples, the microphone 214 may continually record audio, as disclosed herein.

In these examples, the microphone 214 may continually record audio, and the recorded audio may be stored in the data storage component 216. In particular, the data storage component 216 may store an audio buffer of a certain length. That is, as the microphone 214 records audio, the most recently recorded audio may be stored in a buffer (e.g., the most recently recorded 5 minutes of audio). As new audio is recorded, the oldest previously recorded audio may be deleted, such that the buffer continually stores the most recently recorded audio. If the vehicle 102 does not encounter any anomalies, then the audio in the buffer can be deleted, thereby limiting the amount of storage needed to maintain the audio buffer. In some examples, the length of the audio buffer may be based on a speed of the vehicle 102.

However, if the anomaly detection module 302 detects that the vehicle 102 has hit an anomaly, the audio buffer extraction module 306 may extract a portion of the recorded audio to be permanently stored. In particular, the audio buffer extraction module 306 may extract a portion of the audio based on a timing of when the anomaly detection module 302 detects that the vehicle 102 interacted with the anomaly. For example, when the anomaly detection module 302 detects that the vehicle 102 has interacted with an anomaly, the audio buffer extraction module 306 may extract audio beginning at a predetermined time before the vehicle 102 interacted with the anomaly and ending at a predetermined time after the vehicle 102 interacted with the anomaly (e.g., 10 seconds before and 10 seconds after the vehicle 102 interacted with the anomaly). As such, audio of the interaction between the vehicle 102 and the anomaly may be stored even if the vehicle system 200 is not able to determine that the vehicle 102 is approaching the anomaly ahead of time. In some embodiments, the audio buffer extraction module 306 may send the extracted audio to an edge server or a cloud server via V2X communication such that the extracted audio is stored in the edge server or the cloud server.

Referring still to FIG. 3, the data transmission module 308 may transmit data indicating a location of an anomaly detected by the anomaly detection module 302. This may allow other entities to be aware of anomalies detected by the vehicle 102. In one example, the data transmission module 308 may transmit a location of a detected anomaly to a remote computing device, such as an edge server or a cloud computing device. As such, the remote computing device may maintain a database of locations of detected anomalies. Accordingly, other vehicles may communicate with the remote computing device to learn about locations of detected anomalies. In another example, the data transmission module 308 may transmit a location of a detected anomaly to another vehicle (e.g., the vehicle 104 of FIG. 1). This may allow vehicles to be aware of locations of anomalies detected by other vehicles.

Referring still to FIG. 3, the data reception module 310 may receive locations of anomalies from one or more other entities. In one example, the data reception module 310 may receive a location of an anomaly from a remote computing device such as an edge server or a cloud computing device. In particular, a remote computing device may maintain a database of locations of detected anomalies and may transmit locations of detected anomalies to the vehicle 102, which may be received by the data reception module 310. In another example, the data reception module 310 may receive locations of anomalies detected by other vehicles. For example, the vehicle 102 of FIG. 1 may detect the anomaly 108 and transmit its location to the vehicle 104. By receiving a location of a detected anomaly, the audio recording module 304 may cause the microphone 214 to begin recording audio as the vehicle 102 approaches the location of the detected anomaly even if the anomaly detection module 302 does not detect the anomaly. This may increase the chances of the vehicle system 200 successfully recording audio of the interaction with the anomaly.

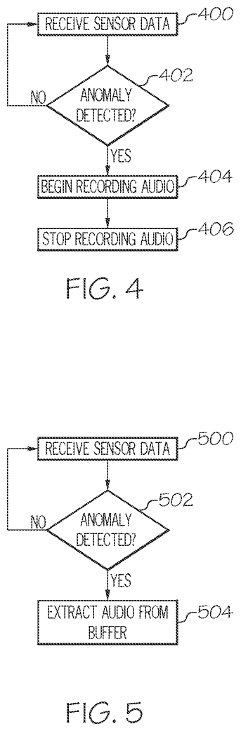

FIG. 4 depicts a flowchart of an example method of operating the vehicle system 200 to perform road sound detection. At step 400, the sensor data reception module 300 receives sensor data from the one or more vehicle sensors 210. The sensor data may contain data indicative of the environment of the vehicle 102 (e.g., features of the road ahead of the vehicle and/or behavior of other vehicles on the road).

At step 402, the anomaly detection module 302 determines whether an anomaly is detected along the trajectory of the vehicle 102. In one example, the anomaly detection module 302 may detect an anomaly based on data received by the sensor data reception module 300. In another example, the anomaly detection module 302 may detect an anomaly based on data received by the data reception module 310 (e.g., a notification from a remote computing device or another vehicle about the location of an anomaly). In addition to detecting the presence of an anomaly, the anomaly detection module 302 may determine the location of the anomaly (e.g., the distance between the vehicle 102 and the anomaly).

If the anomaly detection module 302 determines that an anomaly has not been detected (No at step 402), then control returns to step 400 and the sensor data reception module 300 continues to receive additional sensor data. However, if the anomaly detection module 302 determines that an anomaly has been detected (Yes at step 402), then control passes to step 404.

At step 404, after an anomaly has been detected, the audio recording module 304 causes the microphone 214 to begin recording audio. In some examples, the audio recording module 304 causes the microphone 214 to begin recording audio immediately after the anomaly detection module 302 detects an anomaly. In some examples, the audio recording module 304 causes the microphone 214 to begin recording audio when the distance between the vehicle 102 and the detected anomaly is less than a predetermined threshold distance. In some examples, the audio recording module 304 causes the microphone 214 to begin recording audio when an expected time before the vehicle 102 reaches the detected anomaly is less than a predetermined threshold time.

At step 406, the audio recording module 304 causes the microphone 214 to stop recording audio after the vehicle 102 has passed the anomaly. In some examples, the audio recording module 304 may cause the microphone 214 to stop recording audio after the vehicle 102 has traveled beyond the anomaly by a predetermined threshold distance. In some examples, the audio recording module 304 may cause the microphone 214 to stop recording audio when the vehicle 102 has traveled past the anomaly for greater than a predetermined threshold time. Once the microphone 214 stops recording audio, the recorded audio may be stored in the data storage component 216. Accordingly, if any damage to the vehicle 102 occurs due to the interaction with the anomaly, the recorded audio may be played back for a vehicle technician in order to assist the technician in diagnosing the damage that was done to the vehicle. In some examples, the data transmission module 308 may transmit the determined location of the anomaly to a remote computing device and/or another vehicle in order to assist other vehicles in identifying the anomaly.

FIG. 5 depicts a flowchart of another example method of operating the vehicle system 200 to perform road sound detection. In the example of FIG. 5, the microphone 214 continually records audio, and the most recently recorded audio is stored in a buffer, as described above. At step 500, the sensor data reception module 300 receives sensor data from the one or more vehicle sensors 210.

At step 502, the anomaly detection module 302 determines whether an anomaly has been detected based on the sensor data received by the sensor data reception module 300. In particular, the anomaly detection module 302 may determine whether the vehicle 102 has hit or otherwise interacted with an anomaly. For example, the anomaly detection module 302 may determine that the vehicle 102 has hit an anomaly based on a sudden change to a speed, acceleration, or trajectory of the vehicle 102.

If the anomaly detection module 302 determines that an anomaly has not been detected (No at step 502), then control returns to step 500 and the sensor data reception module 300 continues to receive additional sensor data. Alternatively, the anomaly detection module 302 determines that an anomaly has been detected (Yes at step 502), then control passes to step 504.

At step 504, after an anomaly has been detected, the audio buffer extraction module 306 extracts a portion of the audio stored in the buffer and stores it in the data storage component 216. In some examples, the audio buffer extraction module 306 may extract audio from the buffer recorded over a certain length of time. In some examples, the audio buffer extraction module 306 may extract audio from the buffer recorded while the vehicle 102 has traveled a certain distance. As such, an audio recording of an interaction between the vehicle 102 and the anomaly may be recorded even if the anomaly detection module 302 does not detect the anomaly until after the vehicle 102 reaches the anomaly.

It should now be understood that embodiments described herein are directed to road sound detection. A vehicle system of a vehicle may detect that the vehicle is approaching a road anomaly and may cause a microphone to begin recording audio as the vehicle approaches the anomaly. The audio may continue to be recorded as the vehicle reaches and interacts with the anomaly, and for a short time after reaching the anomaly. As such, the microphone may record the sound of the vehicle interacting with the anomaly. If the anomaly causes any damage to the vehicle, the recorded audio may later be played back to a vehicle technician. The audio may assist the technician in diagnosing the specific damage that was done to the vehicle and determining what repairs are needed.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle system of a vehicle comprising a controller programmed to:
receive sensor data from one or more vehicle sensors as the vehicle drives along a road;
determine whether the vehicle is approaching a road anomaly based on the sensor data; and
upon determination that the vehicle is approaching the road anomaly, begin recording audio and continue recording audio until after the vehicle interacts with the road anomaly.

2. The vehicle system of claim 1, wherein the controller is further programmed to:
determine a location of the road anomaly based on the sensor data; and
transmit the location of the road anomaly to a remote computing device.

3. The vehicle system of claim 1, wherein the controller is further programmed to:
determine a location of the road anomaly based on the sensor data; and
transmit the location of the road anomaly to a second vehicle.

4. The vehicle system of claim 1, wherein:
the sensor data is indicative of driving behavior of a second vehicle; and
the controller is further programmed to determine whether the vehicle is approaching the road anomaly based on the driving behavior of the second vehicle.

5. The vehicle system of claim 1, wherein the controller is further programmed to:
determine a location of the anomaly based on the sensor data; and
begin recording audio when a distance between the vehicle and the location of the anomaly is less than a predetermined threshold distance.

6. The vehicle system of claim 1, wherein the controller is further programmed to:
determine a location of the anomaly based on the sensor data;
determine a speed of the vehicle;
determine a time that the vehicle is estimated to reach the anomaly based on the location of the anomaly and the speed of the vehicle; and
begin recording audio data when the estimated time before the vehicle reaches the anomaly is less than a predetermined threshold time.

7. The vehicle system of claim 1, wherein the controller is further programmed to:
stop recording audio after the vehicle has traveled beyond the anomaly by at least a predetermined threshold distance.

8. The vehicle system of claim 1, wherein the controller is further programmed to:
stop recording audio after the vehicle has traveled beyond the anomaly for at least a predetermined threshold amount of time.

9. The vehicle system of claim 1, wherein the controller is further programmed to:
receive a location of the anomaly from a remote computing device; and
begin recording audio when a distance between the vehicle and the location of the anomaly is less than a predetermined distance.

10. The vehicle system of claim 1, wherein the controller is further programmed to:
receive a location of the anomaly from a second vehicle; and
begin recording audio when a distance between the vehicle and the location of the anomaly is less than a predetermined distance.

11. A vehicle system of a vehicle comprising a controller programmed to:
continually record audio;
store a predetermined amount of the most recently recorded audio in a buffer;
receive sensor data from one or more vehicle sensors;
determine whether the vehicle has interacted with an anomaly based on the sensor data; and
upon determination that the vehicle has interacted with the anomaly, extract a portion of the audio from the buffer.

12. The vehicle system of claim 11, wherein the controller is further programmed to:
determine a timing when the vehicle interacted with the anomaly based on the sensor data; and
extract a predetermined portion of the audio from the buffer based on the timing.

13. The vehicle system of claim 12, wherein the controller is further programmed to:
extract a portion of the audio from the buffer beginning at a first predetermined period of time before the vehicle interacted with the anomaly and ending at a second predetermined period of time after the vehicle interacted with the anomaly.

14. The vehicle system of claim 11, wherein the controller is further programmed to:
determine a location of the anomaly based on the sensor data; and
transmit the location of the anomaly to a remote computing device.

15. The vehicle system of claim 11, wherein the controller is further programmed to:
determine a location of the anomaly based on the sensor data; and
transmit the location of the anomaly to a second vehicle.

16. A method comprising:
receiving sensor data from one or more vehicle sensors of a vehicle as the vehicle drives along a road;
determining whether the vehicle is approaching a road anomaly based on the sensor data; and
upon determination that the vehicle is approaching the road anomaly, beginning to record audio and continuing to record audio until after the vehicle interacts with the road anomaly.

17. The method of claim 16, further comprising:
determining a location of the anomaly based on the sensor data; and
beginning to record audio when a distance between the vehicle and the location of the anomaly is less than a predetermined threshold distance.

18. The method of claim 16, further comprising:
determining a location of the anomaly based on the sensor data;
determining a speed of the vehicle;
determining a time that the vehicle is estimated to reach the anomaly based on the location of the anomaly and the speed of the vehicle; and
beginning to record audio data when the estimated time before the vehicle reaches the anomaly is less than a predetermined threshold time.

19. The method of claim 16, further comprising:
stopping the recording of audio after the vehicle has traveled beyond the anomaly by at least a predetermined threshold distance.

20. The method of claim 16, further comprising:
stopping the recording of audio after the vehicle has traveled beyond the anomaly for at least a predetermined threshold amount of time.
